(19) United States
(12) Patent Application Publication
(10) Pub. No.: US 2024/0145812 A1
(43) Pub. Date: May 2, 2024

(54) APPARATUS FOR COOLING A BATTERY

(71) Applicant: Dr. Ing. h.c. F. Porsche Aktiengesellschaft, Stuttgart (DE)

(72) Inventor: Dominik Grass, Bietigheim-Bissingen (DE)

(73) Assignee: Dr. Ing. h.c. F. Porsche Aktiengesellschaft, Stuttgart (DE)

(21) Appl. No.: 18/492,889

(22) Filed: Oct. 24, 2023

(30) Foreign Application Priority Data
Nov. 2, 2022 (DE) 10 2022 128 913.3

(51) Int. Cl. H01M 10/625; H01M 10/613; H01M 10/6568

(52) U.S. Cl. CPC H01M 10/625; H01M 10/613; H01M 10/6568; H01M 2220/20

(57) ABSTRACT

An apparatus for cooling a battery includes a cooling plate having a cooling channel, and a spacer element disposed in the cooling channel. Also described is a method for producing the apparatus, a battery which includes the apparatus, and a vehicle which includes the apparatus.

### CROSS-REFERENCE TO RELATED APPLICATION

This application claims priority to German Patent Application No. 10 2022 128 913.3, filed Nov. 2, 2022, the content of such application being incorporated by reference herein in its entirety.

### FIELD OF THE INVENTION

The invention relates to an apparatus for cooling a battery, a method for producing the apparatus, and a battery and a vehicle comprising the apparatus.

### BACKGROUND OF THE INVENTION

U.S. Pat. No. 2,013,071 718 A1, which is incorporated by reference herein, discloses a heat dissipation plate for a battery, wherein the heat dissipation plate includes a porous metal foam plate disposed between two sheet metal plates.

### SUMMARY OF THE INVENTION

An apparatus for cooling a battery comprises a cooling plate includes a cooling channel, and a spacer element disposed in the cooling channel.

The cooling plate preferably comprises an edge of the cooling channel, wherein the spacer element extends at least in sections to the edge.

The apparatus preferably comprises two cooling plates between which a compression element is disposed, wherein the spacer element of the respective cooling plate is disposed on a side of the cooling plates facing away from the compression element.

The spacer element of the one cooling plate is preferably disposed offset from the spacer element of the other cooling plate.

The spacer element preferably comprises an undercut that extends substantially along the cooling channel.

A method for producing the apparatus provides that the spacer element is produced by rolling and/or roll forming the cooling plate.

The method for producing the apparatus preferably provides that the compression element is produced by rolling and/or folding with a mold which corresponds to a shape of a side of the cooling plate facing away from the spacer element and wherein the compression element is inserted between two cooling plates.

The method for producing the apparatus preferably provides that the apparatus is cut to length or punched.

A battery comprising the apparatus and a vehicle comprising the apparatus, in particular in its battery, have advantages which correspond to those of the apparatus.

### BRIEF DESCRIPTION OF THE DRAWINGS

Further advantageous embodiments will emerge from the following description and the drawing. The drawing shows:

FIG. 1 depicts steps in a production method for an apparatus for cooling a battery,

FIGS. 2a and 2b depict schematic illustrations of parts of the apparatus.

FIG. 2c depicts a schematic illustration of the apparatus,

FIG. 2d depicts an arrangement of the apparatus in a battery.

### DETAILED DESCRIPTION OF THE INVENTION

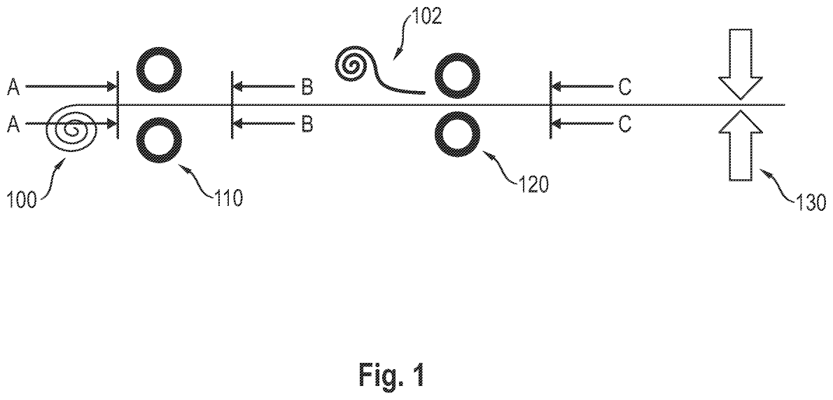

FIG. 1 schematically shows steps in a production method for an apparatus for cooling a battery.

A cooling plate 100 and a compression element 102 are processed in the production method.

In a step 110, spacer elements are produced by rolling and/or roll forming the cooling plate 100.

In a step 120, the compression element 102 is produced by rolling and/or folding with a mold which corresponds to a shape of a side of the cooling plate 100 facing away from the spacer elements 106.

The compression element 102 is preferably inserted between two cooling plates 100 in the same production step.

In a subsequent step 130, the apparatus is cut to length or punched.

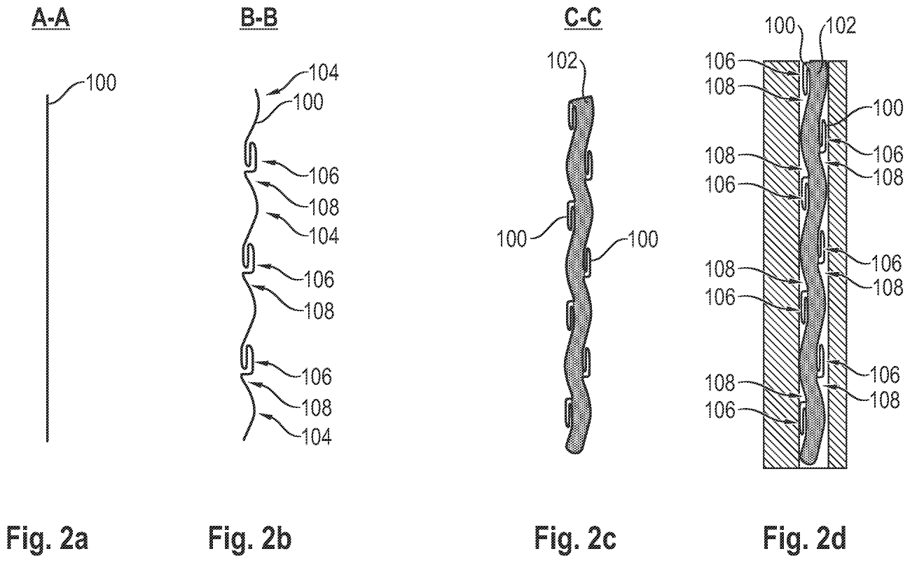

FIG. 2a shows a schematic illustration of a part of the apparatus, namely the cooling plate 100, in accordance with a section A-A through a product created in the production process.

FIG. 2b shows a schematic illustration of parts of the apparatus, namely the cooling plate 100, in accordance with a section B-B through the product created in the production process.

The cooling plate 100 comprises edges 104 and spacer elements 106. A cooling channel 108 is configured between two edges 104. A spacer element 106 is disposed in each cooling channel 108. The spacer element 106 extends at least in sections to the edge 104, i.e., to the height of said edge above the cooling channel 108. The cooling channel 108 extends along the cooling plate 100.

The spacer elements 106 each comprise an undercut that extends substantially along the cooling channel 108.

FIG. 2c shows a schematic illustration of the apparatus, namely a section C-C through the product created in the production process.

The apparatus comprises two cooling plates 100 between which the compression element 102 is disposed.

The spacer elements 106 are disposed on a side of the cooling plate 100 facing away from the compression element 102.

In this example, the spacer elements 106 of the one cooling plate 100 are disposed offset from the spacer elements 106 of the other cooling plate 100.

More or fewer spacer elements 106 can be disposed on the cooling plate 100. More than one spacer element 106 can be disposed in a cooling channel 108. Preferably, a plurality of spacer elements 106 are disposed along the cooling channel 100, i.e., along the direction in which the cooling channel 108 extends in the cooling plate 100, preferably equidistantly or at varying distances from one another.

FIG. 2d shows an arrangement of the apparatus in a battery.

The cooling plate 100 is disposed between two cells of the battery, wherein the respective spacer elements 106 and the edge 104 of the cooling plate 100 maintain the spacing between the cells.

A vehicle can include the cooling plate 100, in particular in its battery. Preferably, a plurality of cooling plates 100 are provided, each of which is disposed between two respective cells of the battery.

What is claimed is:

1. An apparatus for cooling a battery, said apparatus comprising:
a cooling plate defining at least a portion of a cooling channel, and
a spacer element disposed in the cooling channel.

2. The apparatus according to claim 1, wherein at least a portion of the spacer element extends to an edge of the cooling channel.

3. The apparatus according to claim 1, wherein the apparatus comprises two of the cooling plates between which a compression element is disposed, wherein the spacer element of the respective cooling plate is disposed on a side of the cooling plates facing away from the compression element.

4. The apparatus according to claim 3, wherein the spacer element of one of the two cooling plates is disposed offset from the spacer element of the other of the two cooling plates.

5. The apparatus according to claim 1, wherein the spacer element comprises an undercut that extends substantially along the cooling channel.

6. A battery comprising the apparatus according to claim 1.

7. A vehicle comprising the battery of claim 6.

8. A method for producing an apparatus for cooling a battery, said apparatus comprising (a) two cooling plates each defining (i) at least a portion of a cooling channel and (ii) a spacer element disposed in the respective cooling channel, and (b) a compression element disposed between the two cooling plates,
wherein said method comprises, for each cooling plate, producing the spacer element by rolling and/or roll forming the cooling plate.

9. The method according to claim 8, wherein the compression element is produced by rolling and/or folding with a mold which corresponds to a shape of a side of the cooling plate facing away from the spacer element, and wherein the compression element is inserted between two cooling plates.

10. The method according to claim 9, wherein the apparatus is cut to length or punched.
